(19) United States
(12) Patent Application Publication
(10) Pub. No.: US 2012/0127846 A1
(43) Pub. Date: May 24, 2012

(54) OPTICAL INFORMATION DEVICE AND INTERLAYER MOVEMENT METHOD IN OPTICAL INFORMATION DEVICE

(76) Inventor: Kunikazu Ohnishi, Yokosuka (JP)

(21) Appl. No.: 13/293,304

(22) Filed: Nov. 10, 2011

(30) Foreign Application Priority Data
Nov. 24, 2010 (JP) 2010-261160

(51) Int. Cl. G11B 7/1374

(52) U.S. Cl. 369/112.23; G9B/7.121

(57) ABSTRACT

Provided is a method of, in movement between recording layers of an optical disc, resolving a problem caused by an increase in spherical aberration change as a result of widening of a layer interval at which the movement is made and executing appropriate interlayer movement. An upper limit value is defined for a recording layer interval at which the interlayer movement can be made, and if a layer interval from a moving-source layer to a moving-target layer is equal to or larger than the upper limit value, the interlayer movement and spherical aberration correction are once carried out where a predetermined recording layer for which a layer interval is less than the upper limit value is defined as a temporary shelter layer, and the processing is repeated with this temporary shelter layer defined as a new moving-source recording layer to thereby realize favorable interlayer movement to the target layer.

### INCORPORATION BY REFERENCE

This application relates to and claims priority from Japanese Patent Application No. 2010-261160 filed on Nov. 24, 2010, the entire disclosure of which is incorporated herein by reference.

### BACKGROUND OF THE INVENTION

(1) Field of the Invention

The present invention relates to an optical information device optically recording an information signal onto an optical information recording medium (hereinafter, referred to as optical disc) or reproducing the information signal recorded on this optical disc, and an interlayer movement method in the optical information device. The invention more specifically relates to an optical information device suitable for recording or reproducing in a multilayered optical disc on which a plurality of recording layers are laid, and an interlayer movement method in the optical information device.

(2) Description of the Related Art

Optical disc media currently in practical use include: a DVD disc having a recording capacity as large as 4.7 GB (Giga Byte) at a single layer; further a Blue-ray Disc (abbreviated as BD) having great capacity; and so on.

Suggested as these optical disc media is: in addition to conventional types with one or two recording layers, a so-called multi-layered optical disc having three or more recording layers for the purpose of providing even greater capacity, and its standardization and practical realization have been rapidly advanced.

To record or reproduce an information signal in a multilayered optical disc with three or more layers as described above, needless to say, it is required to make so-called interlayer movement of moving from a recording layer at which the recording or reproduction is currently performed to a different recording layer. At this point, a case inevitably arises where the interlayer movement is made not only between adjacent recording layers but also between recording layers arranged with one or more recording layers sandwiched in between.

In such a case, upon interlayer movement of an optical spot irradiated from an optical pickup from a moving-source recording layer to a moving-target recording layer, it is required to perform processing of judging, by counting the number of times of passage through the middle recording layer, whether or not predetermined interlayer movement has been correctly executed.

Then a most common detailed method for counting the number of times of passage through the middle layer is, as disclosed in, for example, Japanese Patent Application Laid-Open No. 2007-207359, etc., a method of counting the number of layers by monitoring a focus control signal waveform of, for example, a focus error signal appearing upon the passage of the optical spot through the middle recording layer.

### SUMMARY OF THE INVENTION

As the number of recording layers in a multilayered optical disc increases and a layer interval between a moving-source recording layer and a moving-target recording layer spreads, deviation of a disc substrate thickness spreads. Therefore, great spherical aberration at an optical spot irradiated to the recording layer arises from the substrate thickness deviation.

Then the occurrence of such relatively great spherical aberration at the optical spot irradiated to the recording layer of the optical disc shows an influence, for example, on a focus control signal waveform of a focus error signal appearing upon passage through a middle recording layer as described above, which may cause a case where its signal waveform is greatly distorted and signal amplitude drastically decreases.

Deterioration in quality of the focus control signal as described above causes an error in counting the number of the middle recording layers performed by monitoring the focus control signal waveform, and also results in failure to correctly pull the optical spot to the recording layer as a moving destination. This results in a problem that interlayer movement on a multilayered optical disc is not correctly performed, leading to failure.

In view of the circumstance as described above, the present invention discloses an optical information device and an interlayer movement method in the optical information device which, in interlayer movement performed at time of recording or reproduction on a multilayered optical disc, avoids erroneous counting of the number of middle recording layers at time of the movement and correctly performs focus pulling to a recording layer as a moving destination.

The object described above can be achieved by the invention described in the scope of claims.

The invention exerts effect of providing an optical information device and an interlayer movement method in the optical information device capable of always efficiently and appropriately executing movement between recording layers in a multilayered optical disc and supplying extremely stable recording and reproduction performance.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing one embodiment of an optical information device of the invention;

FIG. 2A is a schematic configuration diagram showing one example of recording layer configuration of a multilayered optical disc;

FIG. 2B is a schematic configuration diagram showing another example of the recording layer configuration of the multilayered optical disc;

FIG. 3 is a numerical table showing one example of recording layer intervals of the multilayered optical disc;

FIG. 4A is a first schematic diagram schematically showing displacement condition of an objective lens and a focused spot when interlayer movement is carried out on the multilayered optical disc;

FIG. 4B is a second schematic diagram schematically showing displacement condition of the objective lens and the focused spot when the interlayer movement is carried out on the multilayered optical disc;

FIG. 4C is a third schematic diagram schematically showing displacement condition of the objective lens and the focused spot when the interlayer movement is carried out on the multilayered optical disc;

FIG. 4D is a fourth schematic diagram schematically showing displacement condition of the objective lens and the focused spot when the interlayer movement is carried out on the multilayered optical disc;

FIG. 5 is a line diagram showing one example of waveforms of a focus error signal observed when the interlayer movement is carried out on the multilayered optical disc;

FIG. 6 is a line diagram showing another example of the waveforms of the focus error signal observed when the interlayer movement is carried out on the multilayered optical disc; and

FIG. 7 is a flow chart showing one embodiment of procedures of interlayer movement processing of the invention.

### DETAILED DESCRIPTION OF THE EMBODIMENT

Hereinafter, a mode for carrying out the present invention will be described.

Hereinafter, an embodiment of the invention will be described with reference to the drawings.

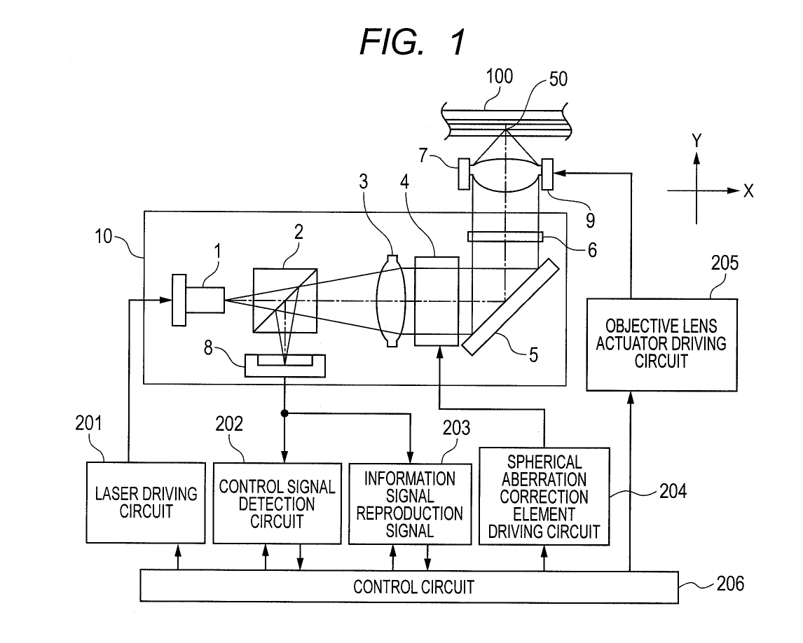

FIG. 1 is a block diagram showing one embodiment of an optical information device of the invention.

Arranged in an optical pickup device 10 are main optical components including: a semiconductor laser light source 1 that emits a laser beam in a wavelength band of 640 nm as a recording or reproducing light source of, for example, a BD; a polarized light beam splitter (PBS) 2; a collimating lens 3; a spherical aberration correction element 4; a standup mirror 5; a quarter-wavelength plate 6; an objective lens 7; and a light detector 8.

First, the laser beam emitted from the semiconductor laser light source 1 is focused by the objective lens 7 after passing through the optical components, and irradiated as a predetermined focused spot 50 to a predetermined recording layer in a multilayered optical disc 100.

Then a reflected beam of the focused spot 50 reflected on the recording layer travels on the substantially same optical path as that of an outward way in a direction opposite to a direction of the light beam on the outward way, is reflected on the PBS 2, then enters into a predetermined light-receiving face in the light detector 8, and a predetermined photoelectric conversion signal is detected on this light-receiving face.

Detailed configuration and functions of the individual optical components described above are not directly related to the invention and thus their detailed descriptions will be omitted.

As described above, the photoelectric conversion signal detected on the predetermined light-receiving face in the light detector 8 is transmitted to a control signal detection circuit 202 and an information signal reproduction circuit 203, so that various control signals, i.e., so-called a focus control signal and a tracking control signal, which are used for position control of the focused spot 50 and an information signal recorded on the recording layer of the optical disc are reproduced.

Connected to the objective lens 7 is a predetermined two-dimensional actuator 9. This two-dimensional actuator 9 is driven through an objective lens actuator driving circuit 205 by the focus and tracking control signals, and focus and tracking controls of the objective lens 7 are performed.

Further, the objective lens actuator driving circuit 205 and the two-dimensional actuator 9 have a function of freely changing a position of the objective lens 7 in an optical direction (Y-axis direction in the figure) and moving the focused spot 50 to any recording layer in the multilayered optical disc 100.

To the semiconductor laser light source 1, a laser driving circuit 201 is connected, and upon recording a predetermined information signal onto a predetermined recording layer in the multilayered optical disc 100 or reproducing the information signal already recorded on the recording layer, for example, a light amount of the laser beam emitted from the semiconductor laser light source 1 is controlled as needed.

Moreover, the spherical aberration correction element 4, as described below, has a function of removing or dramatically reducing spherical aberration occurring upon the movement of the focused spot 50 to any recording layer in the multilayered optical disc 100 and always holding a favorable focus state of the focused spot 50 upon irradiation of the focused spot 50 to any recording layer.

Further, connected to this spherical aberration correction element 4 is a spherical aberration correction element driving circuit 204, which controls the spherical aberration correction element 4 to optimize the spherical aberration removal function in accordance with an irradiation position of the focused spot 50.

Note that detailed configuration of the spherical aberration correction element 4 is not limited to any specific configuration, and an element with any configuration that includes required performance is acceptable and therefore detailed configuration thereof is not shown in the figure.

Moreover, the laser driving circuit 201, the control signal detection circuit 202, the information signal reproduction circuit 203, the spherical aberration correction element driving circuit 204, and the objective lens actuator driving circuit 205 are each connected to a control circuit 206, which integrally controls their functions.

Further, connected to the multilayered optical disc 100 is a spindle motor for rotationally driving this disc around a predetermined rotation axis, although this spindle motor is not shown in FIG. 1 since it is not directly related to the invention. For the purpose of rotationally driving the multilayered optical disc 100 at a predetermined rotation speed, driving of this spindle motor is controlled by the control circuit 206 through a spindle motor driving circuit.

Needless to say, the configuration shown in FIG. 1 shows just one embodiment of the optical information device and the invention is not limited to this configuration. An optical information device with any configuration is acceptable as long as it includes a function of recording or reproducing an information signal by using a multilayered optical disc having three or more recording layers.

Next, a detailed embodiment of the multilayered optical disc 100 used in the optical information device as shown in FIG. 1 will be described.

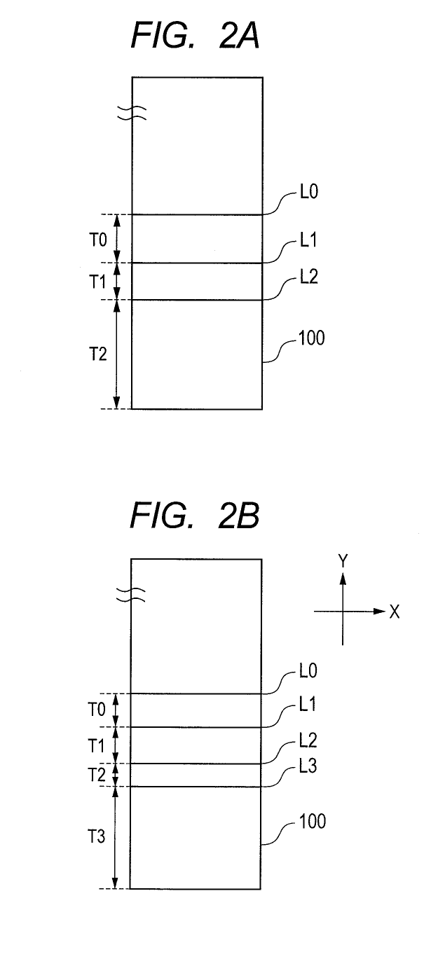

FIGS. 2A and 2B show detailed examples of the multilayered optical disc 100 whose standards is currently defined as a multilayered BD (abbreviated as BD-XL) and which has been rapidly put into practice, where FIG. 2A is a schematic sectional view of a three-layered disc and FIG. 2B is a schematic sectional view of a four-layered disc. Note that a surface at bottom of the figures is a side facing the objective lens 7, and the laser beam focused by the objective lens 7 is irradiated from the bottom to top in the figures.

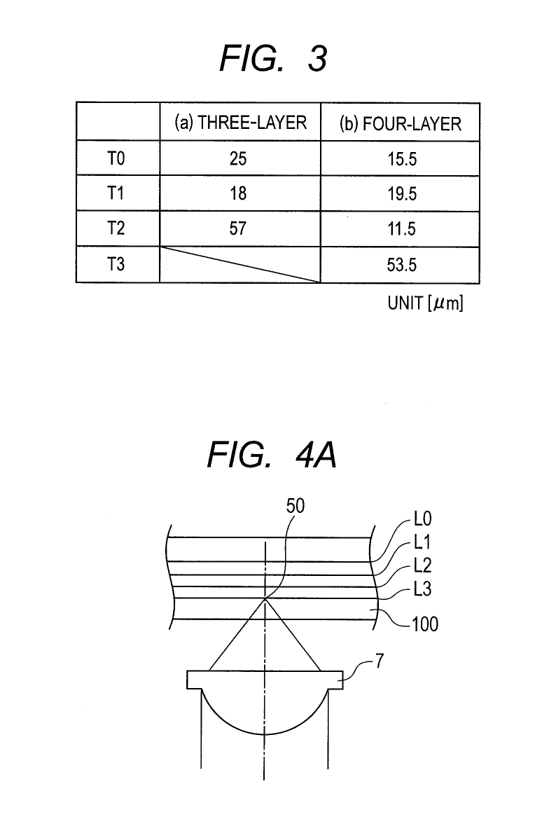

Including a numerical table showing one example of recording layer intervals of the multilayered optical disc shown in FIG. 3, the three-layered disc and the four-layered disc will be described.

First, laid in the three-layered disc of FIG. 2A are a total of three recording layers including a layer L0, a layer L1, and a layer L2 from a remotest side when viewed from an objective lens side (bottom in the figure). Where intervals between the recording layers and an interval from the layer L2 to a disc surface are: (T0), (T1), and (T2), respectively, their detailed interlayer intervals (central values) are defined by a standard as in a left column of FIG. 3.

On the other hand, laid in the four-layered disc of FIG. 2B are a total of four recording layers including a layer L0, a layer L1, a layer L2, and a layer L3 from a remotest side when viewed from an objective lens side (bottom in the figure). Where intervals between the recording layers and an interval from the layer L3 to the disc surface are: (T0), (T1), (T2), and (T3), respectively, their detailed interlayer intervals (central values) are defined by the standard as in a right column of FIG. 3.

The focused spot is displaced along an optical axis direction (Y-axis direction in the figure) when needed, and thereby moves between these recording layers.

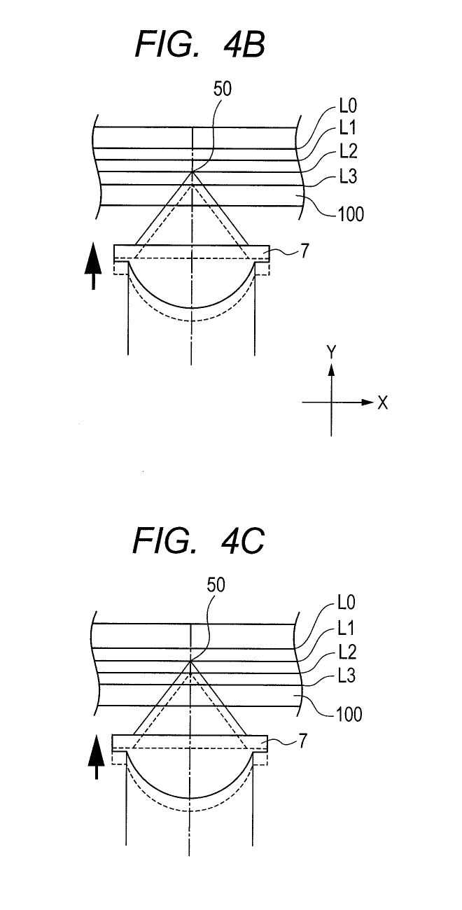

Referring to schematic diagrams of displacement condition of the objective lens and the focused spot shown in FIGS. 4A to 4D, the movement of the focused spot between the recording layers will be described.

For example, assume a case of a four-layered disc having a structure as shown in FIG. 2B. Now assume that, as shown in FIG. 4A, the focused spot 50 is irradiated to the layer L3 located on a nearest side when viewed from the objective lens side.

Then the two-dimensional actuator 9 is driven in this state to move at once the focused spot 50 to a furthest side when viewed from the objective lens side.

At this point, the focused spot 50 passes through the layer L2 and the layer L1 as shown in FIGS. 4B and 4C, respectively before arriving at the layer L0. Then at instance of passage through each of these recording layers, a focus control signal waveform appears. A device side can, for example, count the number of times of detection of this focus control signal waveform to thereby recognize an instantaneous position of the focused spot 50 under interlayer movement.

Moreover, upon the arrival of the focused spot 50 at the layer LO (state of FIG. 4D), the focused spot needs to be correctly landed on this layer L0. Control of the landing of the focused spot 50 at this point is also executed by use of this focus control signal waveform appearing upon the passage of the focused spot 50 through the layer L0.

In other words, interlayer movement performance in the multilayered disc is largely influenced by how satisfactorily and correctly this focus control signal waveform can be detected.

On the other hand, however, the detection of the focus control signal waveform in the interlayer movement in the multilayered disc causes a big problem as shown below.

Specifically, in irradiation of the laser beam focused by the objective lens to the predetermined recording layer in the multilayered optical disc 100, it is needless to say that the irradiation to the predetermined recording layer is performed through a transparent layer of , for example, glass or plastic, such as a protection layer (referred to a layer forming from the recording layer located on a closest side when viewed from the objective lens side to the disc surface) or a middle layer (referred to a layer filling between the adjacent recording layers). Thus, in a case of the multilayered optical disc, a thickness of the aforementioned transparent layer through which the laser beam passes varies between the recording layers to which the focused spot is irradiated.

This variation in the thickness of the transparent layer through which the laser beam passes provides a difference in a quantity of spherical aberration added to the focused spot irradiated to each recording layer.

For example, assume a case of interlayer movement in the four-layered disc described above.

Now, as shown in FIG. 4A, when the focused spot 50 is irradiated to the layer L3, the thickness (T3) of the transparent protection layer through which the laser beam forming the focused spot 50 passes is 53.5 μm.

Thus, assume that the driving of the spherical aberration correction element 4 shown in FIG. 1 described above is first controlled in order to optimize a focus state of the focused spot 50 in this state.

Next, assume that the two-dimensional actuator 9 and the objective lens 7 connected thereto are moved in this state, and the focused spot 50 is moved sequentially through the layer L2, the layer L1, and the layer L0.

At this point, for example, when the focused spot 50 has arrived at the layer L2 as in FIG. 4B, the thickness of the transparent layer through which this laser beam passes is (T3)+(T2), a value of which is 53.5+11.5=65 μm as can be seen from FIG. 3.

Completely in the same manner, when the focused spot 50 has arrive at the layer L1 as in FIG. 4C, the thickness of the transparent layer through which this laser beam passes is (T3)+(T2)+(T1), a value of which is 53.5+11.5+19.5=84.5 μm as can be seen from FIG. 3.

Further, when the focused spot 50 has arrived at the layer L0 as in FIG. 4D, the thickness of the transparent layer through which this laser beam passes is (T3)+(T2)+(T1)+(T0), a value of which is 53.5+11.5+19.5+15.5=100 μm as can be seen from FIG. 3.

Specifically, when the focused spot 50 moves from the layer L3 located on the nearest side to the layer LO located on the furthest side, the thickness of the transparent layer through which the laser beam passes is from 53.5 μm to 100 μm, that is, the thickness changes approximately 46 μm.

Therefore, when the focused spot 50 is moved to the layer L0 at once in a state in which the driving of the spherical aberration correction element 4 is controlled in order to optimize the focus state when the focused spot 50 is irradiated to the layer L3, as the laser beam travels to the layer L2, the layer L1 and then the layer L0, residual spherical aberration that cannot be completely removed with the spherical aberration correction element 4 rapidly increases due to the variation in the thickness of the transparent layer through which the laser beam passes, resulting in increasing deterioration of the focus state of the focused spot 50.

Thus, as the focused spot 50 travels to the layer L2, the layer L1, and then the layer L0, the focus control signal waveform detected from the focused spot 50 whose focus state has deteriorated as described above also increasingly deteriorates in its signal waveform quality, its amplitude decreases, and great waveform distortion occurs.

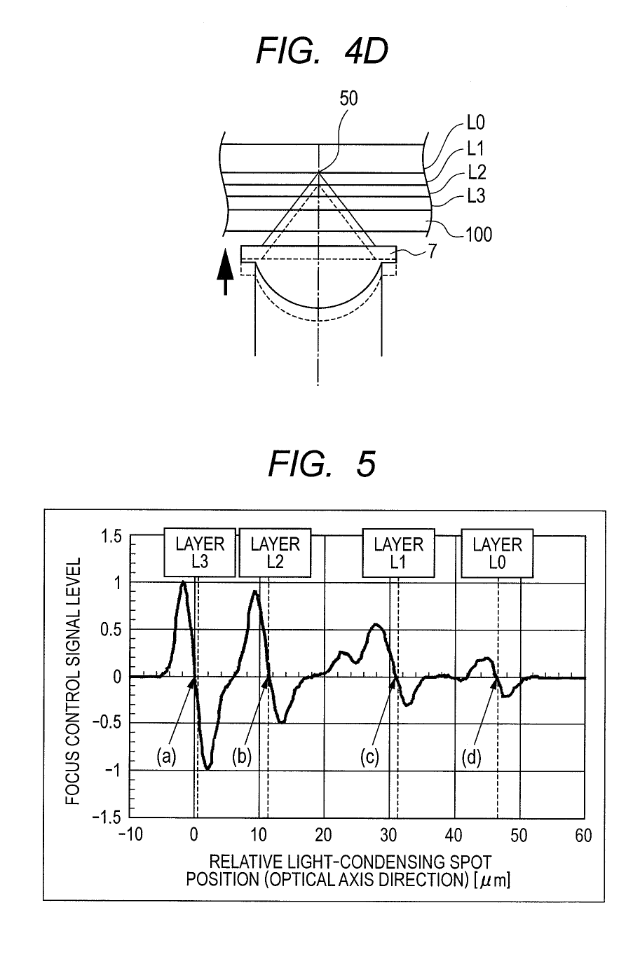

FIG. 5 is a diagram showing one example of the focus control signal waveform obtained when the focused spot 50 makes the interlayer movement from the layer L3 to the layer L0 in the four-layered BD disc 100.

A horizontal axis of the figure denotes a position of the focused spot 50 relative to the optical axis direction with a position of the layer L3 as a reference. A vertical axis of the figure denotes in a relative value a focus control signal level appearing upon the passage through each of the layers from the layer L3 to the layer L1 where the focus control signal amplitude upon the passage through the layer L3 is ±1. In this example, an amount of spherical aberration correction of the spherical aberration correction element 4 is controlled so that the focus state of the focused spot 50 is optimized when the focused spot 50 is irradiated to the layer L3.

As it is obvious from FIG. 5, in a case where the spherical aberration correction is performed so that the focus state of the focused spot 50 is optimized when the focused spot 50 is irradiated to the layer L3, as the focused spot 50 moves further away from the layer L3, gradually from the layer L2, the layer L1, and the layer L0, a focus control signal appearing upon the passage through each recording layer experiences a decrease in its amplitude and great distortion in its waveform itself.

For example, in the example of FIG. 5, a detailed analysis of the quality of this focus control signal waveform shows that, for the layers from the layer L2 to the layer L1, counting the focus control signal appearing there makes it possible to determine at which recording layer the focused spot 50 has arrived and also makes it possible to have the focused spot 50 correctly land at this recording layer by use of the focus control signal waveform of each layer, but for the layer L0, quality deterioration of this focus control signal waveform is too remarkable and thus it is difficult to correctly count the signal waveform or have the focused spot 50 correctly land at the layer L0 by use of the focus control signal.

In other words, in an example as in FIG. 5, it is practically impossible to make interlayer movement from the layer L3 to the layer L0 at once. Thus, in this embodiment, the interlayer movement from the layer L3 to the layer L0 is realized with the following procedures.

Specifically, an upper limit value (TL) of a recording layer interval that permits interlayer movement is first defined and previously registered into the device. For example, in the example of FIG. 5, this upper limit value (TL) is 33 μm.

Then the recording layer interval from the layer L3 to the layer 0 is approximately 46 μm as described above, which is a value larger than the upper limit value (TL)=33 μm, in which case therefore the interlayer movement from the layer L3 to the layer L0 at once is not permitted.

On the other hand, the recording layer interval from the layer L3 to the layer L1 is converted from FIGS. 3, and (T1)+(T2) is equal to approximately 31 μm, which is smaller than the upper limit value (TL)=33 μm, which therefore permits the interlayer movement from the layer L3 to the layer L1.

Thus, to make the interlayer movement from the layer L3 to the layer L0, interlayer movement from the layer L3 to the layer L1 is first made, the focused spot 50 is correctly landed at the layer L1, and then the spherical aberration correction element 4 is driven to perform spherical aberration correction so that the focus state of the focused spot 50 is optimized when the focused spot 50 is irradiated to the layer L1.

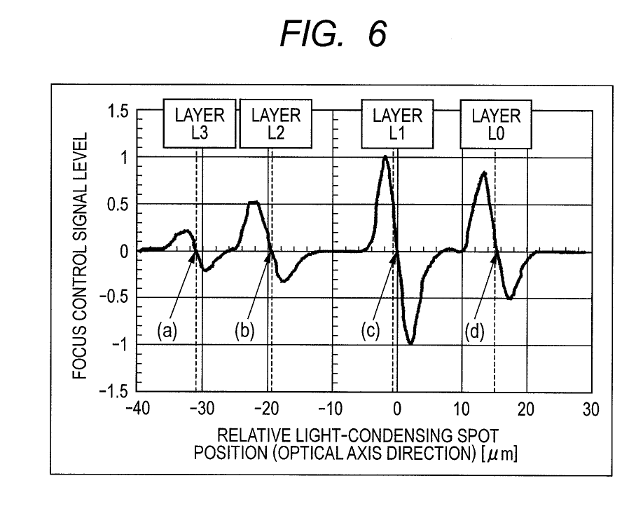

FIG. 6 is a diagram showing a focus control signal waveform appearing at each recording layer in a state in which the spherical aberration correction is performed so that the focus state of the focused spot 50 is optimized when the focused spot 50 is irradiated to the layer L1.

A horizontal axis of this figure is, as is with FIG. 5, a position of the focused spot 50 relative to the optical axis direction. However, its reference position is different from that of FIG. 5, and a position of the layer L1 is defined as the reference position. Moreover, a vertical axis of this figure, as is with FIG. 5, denotes in a relative value a focus control signal level, but unlike FIG. 5, defines the focus control signal amplitude at time of the passage through the layer L1 as ±1.

As can be seen from FIG. 6, when the focused spot 50 is once correctly landed at the layer L1 and the spherical aberration correction element 4 is further driven to perform the spherical aberration correction so that the focus state of the focused spot 50 is optimized when the focused spot 50 is irradiated to the layer L1, it is needless to say that the focus control signal appearing at the time of the passage through the layer L1 shows dramatic improvement in its signal amplitude and waveform distortion, compared to the case of FIG. 5.

Further, for a focus control signal appearing at time of the passage through the layer LO adjacent to the layer L1, its amplitude and waveform distortion dramatically improve.

Furthermore, an interlayer interval between the layer L1 and the layer L0 is, from FIG. 3, (TO)=15.5 μm, which is sufficiently smaller than the upper limit value (TL)=33 μm. Therefore, the interlayer movement from the layer L1 to the layer L0 is permitted and can be executed without any trouble.

To make movement between the recording layers with a wide interlayer interval as described above, the interlayer movement and the spherical aberration correction can be carried out in several divided steps, and divided movements can efficiently and reliably be performed by defining, as a judgment criteria for the divided movement, the upper limit value (TL) of the interlayer interval that permits the interlayer movement as described above at a predetermined value.

The description above referred to the interlayer movement from the layer L3 to the layer L0 in the four-layered BD disc as a most typical embodiment of the invention, but needless to say, the invention is not limited to this. For example, oppositely to the example described above, to interlayer movement from the layer L0 to the layer L3, a method of the divided movement of this embodiment is also applicable, and it is also applicable to interlayer movement between any other recording layers.

For example, in a case of the interlayer movement between the layer L2 and the layer L0, the layer interval between the two recording layers is (T1)+(T0)=35 μm, which is larger than the aforementioned upper limit value (TL)=33 μm; therefore, instead of making the interlayer movement from the layer L2 to the layer L0 at once, the interlayer movement from the layer L2 to the layer L1 and spherical aberration correction can be first performed and then the interlayer movement from the layer L1 to the layer L0 can be executed.

Moreover, an optical disc medium concerned is, needless to say, not limited to the four-layered disc described in the above example, and this embodiment is also applicable to a three-layered disc shown in FIG. 2C and a high-layered disc with five or more layers that will be rapidly put into practice in the future.

Various methods can be assumed as a method of the spherical aberration correction in this embodiment. For example, in the examples described in FIGS. 5 and 6, the spherical aberration correction is performed so that the best focus state is provided when the focused spot is irradiated to the recording layer as a source of the interlayer movement; however, for an actual optical information device or optical pickup device for an multilayered disc, a correction method is not limited to such a correction method. Also assumed are: for example, a method of performing spherical aberration correction so that the best focus state is provided when the focused spot is irradiated to the recording layer as a destination of the interlayer movement; and a method of performing spherical aberration correction so that the best focus state of the focused spot is provided with a thickness of the transparent layer in the middle between the source of the interlayer movement and the destination of the interlayer movement.

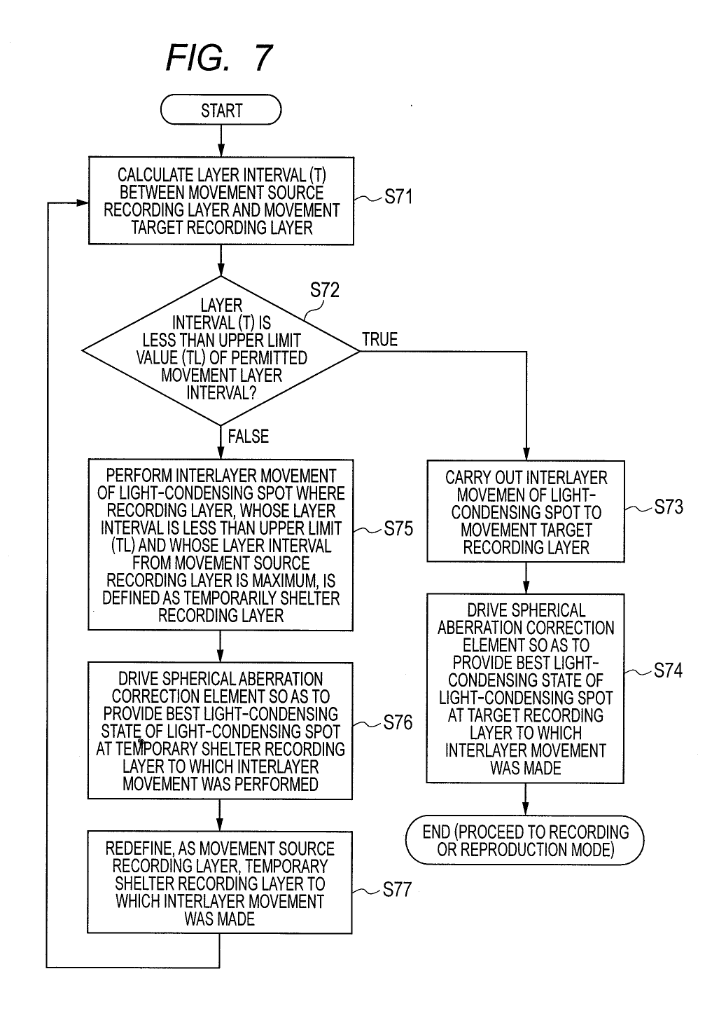

FIG. 7 is a flow chart showing an embodiment of procedures of interlayer movement processing according to the invention.

Upon start of the interlayer movement processing, the control circuit 206 first calculates, from each recording layer interval data of the concerned multilayered optical disc (as previously shown in FIG. 3) previously stored in the device, a layer interval value (T) between the moving-source recording layer (recording layer currently irradiated with the focused spot) and the moving-target recording layer (step S71).

Next , the control circuit 206 determines whether or not this layer interval value (T) is smaller than the upper limit value (TL) of the layer interval which permits movement and which is previously registered in the device (step S72).

If a result of this determination is “TRUE (correct), that is, the layer interval value (T) is less than the upper limit value (TL)”, the control circuit 206 controls the objective lens actuator driving circuit 205 to have the focused spot make interlayer movement directly to the moving-target recording layer (step S73), and also controls the spherical aberration correction element driving circuit 204 to drive the spherical aberration correction element 4 in order to provide the best focus state of the focused spot at the target recording layer to which the movement has been made (step S74).

On the other hand, if the result of the determination is “FALSE (incorrect)), that is, the layer interval value (T) is equal to or larger than the upper limit value (TL)”, the control circuit 206 controls the objective lens actuator driving circuit 205 to have the focused spot once make interlayer movement to the recording layer for which the layer interval value from the moving-source recording layer is less than the upper limit value (TL), that is, the recording layer which is located on the nearer side than the moving-target recording layer when viewed from the moving-source recording layer and also which meets predetermined condition, for example, the recording layer for which the layer interval value from the moving-source recording layer is maximum (hereinafter referred to, for simplification, as temporary shelter recording layer) (step S75).

Then on this temporary shelter recording layer, the control circuit 206 controls the spherical aberration correction element driving circuit 204 to drive the spherical aberration correction element 4 in order to provide the best focus state of the focused spot (step S76).

Then this temporarily shelter recording layer is newly treated as the moving-source recording layer (step S77), and the processing returns to the process (step S71) of calculating by the control circuit 206 the layer interval value (T) between this moving-source recording layer and the moving-target recording layer. A processing routine described above is repeated until the focused spot arrives at the moving-target recording layer fist set.

The above is one example of the procedures of the interlayer movement processing of this embodiment.

For the embodiment described above, shown is a processing example of selecting as the temporarily shelter recording layer the recording layer which is located on the nearer side than the moving-target recording layer when viewed from the moving-source recording layer and for which the layer interval value from the moving-source recording layer is maximum, but the invention, needless to say, is not limited to this, and any selection condition is permitted as long as the condition is such that the layer interval value from the moving-source recording layer is less than the upper limit value (TL) , that is, the recording layer is located on the nearer side than the moving-target recording layer when viewed from the moving-source recording layer. Moreover, the optical information device according to the invention may have a mode such that a function of recording information is not provided but a function of reproduction is provided. Modes obtained by adding modification to the mode described above are possible, each of which is in the scope of the invention.

While we have shown and described several embodiments in accordance with our invention, it should be understood that disclosed embodiment is susceptible of changes and modifications without departing from the scope of the invention. Therefore, we do not intend to be bound by the details shown and described herein but intend to cover all such changes and modifications that fall within the ambit of the appended claims.

What is claimed is:

1. An optical information device irradiating, in an optical disc including at least three recording layers, a focused spot of laser light to the recording layer in the optical disc to reproduce an information signal from the recording layer or recording the information signal onto the recording layer, the optical information device comprising:
a laser light source emitting the laser light;
a spherical aberration correction element being irradiated with the laser light emitted at the laser light source and correcting spherical aberration at the focused spot of the laser light irradiated to the recording layer via the laser light source;
a spherical aberration correction element driving circuit moving a position of the spherical aberration correction element relative to the recording layer;
an objective lens being irradiated with the laser light passing through the spherical aberration correction element to generate the focused spot of the laser light at the recording layer;
an objective lens actuator moving a position of the objective lens relative to the recording layer;
an objective lens actuator driving circuit driving the objective lens actuator;
a light detector receiving reflection light of the laser light from the recording layer and converting the reflection light into an electrical signal; and
a control circuit controlling components of the optical information device including the spherical aberration correction element driving circuit and the objective lens actuator driving circuit,
wherein the control circuit, upon moving the focused spot from the predetermined moving-source recording layer in the optical disc to the moving-target recording layer different from the moving-source recording layer, defines a predetermined upper limit value (TL) for a layer interval that permits movement of the focused spot between the recording layers, and
when a recording layer interval value (T) between the moving-source recording layer and the moving-target recording layer is equal to or larger than the predetermined upper limit value (TL), controls the objective lens actuator driving circuit and repeats operation of once moving the focused spot while the different recording layer for which a layer interval from the moving-source recording layer is less than the upper limit value (TL) is defined as a temporary shelter recording layer and then, while the temporary shelter recording layer is defined as a new moving-source recording layer, moving the focused spot to the different recording layer for which a layer interval from the moving-source recording layer is less than the upper limit value (TL) to thereby move the focused spot to the moving-target recording layer.

2. The optical information device according to claim 1,
wherein the control circuit, after moving the focused spot from the predetermined moving-source recording layer in the optical disc to the temporary shelter recording layer, controls the spherical aberration correction element driving circuit, and between the temporary shelter recording layer and the recording layer as a next moving destination from the temporary shelter recording layer when the temporary shelter recording layer is defined as a new moving-source recording layer, moves the spherical aberration correction element in order to correct spherical aberration of the focused spot.

3. The optical information device according to claim 1,
wherein the control circuit changes the predetermined upper limit value (TL) in accordance with the number of recording layers in the optical disc.

4. The optical information device according to claim 1,
wherein the control circuit changes the predetermined upper limit value (TL) in accordance with spherical aberration in the optical disc.

5. An interlayer movement method in an optical information device irradiating, in an optical disc including at least three recording layers, a focused spot of laser light to the recording layer in the optical disc to reproduce an information signal from the recording layer or recording the information signal onto the recording layer, the interlayer movement method comprising:
upon interlayer movement of the recording layer irradiated with the focused spot of the laser light from the moving-source recording layer to the moving-target recording layer,
a layer interval calculation step of calculating a layer interval (T) between the moving-source recording layer and the moving-target recording layer;
a layer interval determination step of determining whether or not the layer interval (T) calculated in the layer interval calculation step is less than a predetermined upper limit value (TL) of a layer interval that permits movement;
a first focused spot movement step of, when it is determined as a result of the determination in the layer interval determination step that the layer interval (T) is less than the predetermined upper limit value (TL) of the layer interval that permits movement, moving the focused spot to the moving-target recording layer;
a first spherical aberration correction step of correcting spherical aberration of the focused spot at the moving-target recording layer when the focused spot is moved to the moving-target recording layer in the first focused spot movement step;
a second focused spot movement step of, when it is determined as a result of the determination in the layer interval determination step that the layer interval (T) is equal to or larger than the predetermined upper limit value (TL) of the layer interval that permits movement, making interlayer movement of the focused spot where the recording layer for which a layer interval from the moving-source recording layer is less than the upper limit value (TL) of the layer interval that permits movement and also maximum is defined as a temporary shelter recording layer;
a second spherical aberration correction step of, upon the movement of the focused spot to the temporary shelter recording layer in the second focused spot movement step, correcting spherical aberration of the focused spot between the temporary shelter recording layer and the recording layer as a next moving destination when the temporary shelter recording layer is defined as a new moving-source recording layer; and
a moving source recording layer resetting step resetting the temporary shelter recording layer as the moving source recording layer for the interlayer movement.

6. An optical information device irradiating, in an optical disc including at least three recording layers, a focused spot of laser light to the recording layer in the optical disc to reproduce an information signal from the recording layer or recording the information signal onto the recording layer, the optical information device comprising:
a laser light source emitting the laser light;
a spherical aberration correction element being irradiated with the laser light emitted at the laser light source and correcting spherical aberration at the focused spot of the laser light irradiated to the recording layer via the laser light source;
a spherical aberration correction element driving circuit moving a position of the spherical aberration correction element relative to the recording layer;
an objective lens being irradiated with the laser light passing through the spherical aberration correction element to generate the focused spot of the laser light at the recording layer;
an objective lens actuator moving a position of the objective lens relative to the recording layer;
an objective lens actuator driving circuit driving the objective lens actuator;
alight detector receiving reflection light of the laser light from the recording layer and converting the reflection light into an electrical signal; and
a control circuit controlling components of the optical information device including the spherical aberration correction element driving circuit and the objective lens actuator driving circuit,
wherein the control circuit, upon moving the focused spot from the predetermined moving-source recording layer in the optical disc to the moving-target recording layer different from the moving-source recording layer, moves the focused spot from the predetermined moving-source recording layer in the disc to a temporary shelter recording layer lying between the moving-source recording layer and the moving-target recording layer, and then controls the spherical aberration correction element driving circuit to move the spherical aberration correction element in a manner such as to correct the spherical aberration of the focused spot.

7. An interlayer movement method in an optical information device irradiating, in an optical disc including at least three recording layers, a focused spot of laser light to the recording layer in the optical disc to reproduce an information signal from the recording layer or recording the information signal onto the recording layer,
wherein, upon movement of the recording layer, to which the focused spot of the laser light is irradiated, from the moving-source recording layer to the moving-target recording layer, the focused spot is moved from the predetermined moving-source recording layer in the optical disc to a temporary shelter recording layer lying between the moving-source recording layer and the moving-target recording layer, and then the spherical aberration of the focused spot is corrected.
